(19) United States
(12) Patent Application Publication
(10) Pub. No.: US 2009/0279529 A1
(43) Pub. Date: Nov. 12, 2009

(54) Synchronization in Mobile Communication System

(76) Inventors: Jyri Hamalainen, Oulu (FI); Risto Wichman, Helsinki (FI); Vinh Van Phan, Oulu (FI); Antti Sorri, Helsinki (FI); Kari Horneman, Oulu (FI)

Correspondence Address: Hollingsworth & Funk, 8500 Normandale Lake Blvd., Suite 320, Minneapolis, MN, 55437, US

(21) Appl. No.: 12/360,261

(22) Filed: Jan. 27, 2009

(30) Foreign Application Priority Data
May 8, 2008 (FI) 20085423

(51) Int. Cl. H04J 3/06

(52) U.S. Cl. 370/350

(57) ABSTRACT

A solution to overcome synchronization problems related to a scenario where multiple radio access networks utilize a shared frequency band in a radio communication environment is provided. The radio access networks are synchronized to a common synchronization source which may be a synchronization signal broadcasted by another radio system. The synchronization source is selected from a predetermined set of synchronization signals according to the availability of the synchronization signals for transmitters of the radio access networks.

### FIELD

The invention relates to the field of radio telecommunications and, particularly, to transmission synchronization in a mobile communication system.

### BACKGROUND

Flexible spectrum use has become an attractive technology topic in relation to the latest evolution versions of mobile communication systems. In general, flexible spectrum use refers to adaptive and variable use of radio spectrum, wherein a given frequency band may be occupied by different radio access networks and the frequency band occupation may be changed as a function of time or space. As an example, a given frequency band may be shared by radio access networks of two different network operators, and the utilization of the frequency band is changed in time so that the distribution of the frequency resources between the two operators is time-variable. In another example, the frequency band is shared by radio access networks based on different radio communication protocols, such as GSM (Global System for Mobile Communications) and UMTS (Universal Mobile Telecommunication System).

In order to prevent overlapping utilization of the frequency band and to provide efficient utilization of the frequency band, transmission of the two radio access networks should be synchronized. Transmission synchronization based on satellite radio systems, such as Global Positioning System (GPS) is known in the art. A problem with synchronization to satellite radio systems is that the coverage area of the satellite radio systems does not extend beyond obstacles such as building structure. Therefore, base stations located inside buildings are not capable of acquiring synchronization directly from the satellite radio system. This problem is emphasized in a radio access network comprising privately owned base stations dedicated to serving only a specific group of mobile terminals. These private base stations (also known as Home Node B's) are connected to an operator network through xDSL (Digital Subscriber line) connections. Information exchange between a private base station and neighboring base stations is very limited and slow and, thus, synchronization based on communication between a private base station (not able to synchronize directly to the satellite radio system) and neighboring base stations (able to synchronize directly to the satellite radio system) may not be possible to realize. Synchronization over the DSL connection may neither be feasible due to the unpredictable nature of the connection. Synchronization methods targeted to wired networks are often sensitive to packet delay variations and, therefore, not accurate enough. Accordingly, a need exists for efficient transmission synchronization in an environment where flexible spectrum use is implemented.

### BRIEF DESCRIPTION

According to an aspect of the present invention, there is provided a method including determining the availability of a set of synchronization channels for use in a radio access network of a mobile communication system. At least part of the set of synchronization channels is broadcasted by one or more radio systems other than the mobile communication system, and the radio access network operates on a frequency band shared by a plurality of radio access networks. The method also includes selecting a synchronization channel to be used for synchronization from the set of synchronization channels according to a determined criterion. Further, one or more transmitters of the radio access network is configured to synchronize transmission to a synchronization signal broadcasted on the selected synchronization channel.

According to another aspect of the present invention, there is provided an apparatus including a processor. The processor is configured to determine the availability of a set of synchronization channels for use in a radio access network of a mobile communication system and to select a synchronization channel to be used for synchronization from the set of synchronization channels according to a determined criterion. The processor is further configured to configure one or more transmitters of the radio access network to synchronize transmission to a synchronization signal broadcasted on the selected synchronization channel. At least part of the set of synchronization channels is broadcasted by one or more radio systems other than the mobile communication system, and the radio access network operates on a frequency band shared by a plurality of radio access networks.

According to another aspect of the present invention, there is provided an apparatus including means for determining the availability of a set of synchronization channels for use in a radio access network of a mobile communication system and means for selecting a synchronization channel to be used for synchronization from the set of synchronization channels according to a determined criterion. The processor further includes means for configuring one or more transmitters of the radio access network to synchronize transmission to a synchronization signal broadcasted on the selected synchronization channel. At least part of the set of synchronization channels is broadcasted by one or more radio systems other than the mobile communication system, and the radio access network operates on a frequency band shared by a plurality of radio access networks.

According to yet another aspect of the present invention there is provided a computer program product embodied on a computer readable distribution medium having program instructions which, when loaded into an apparatus, execute a computer process. The process includes determining the availability of a set of synchronization channels for use in a radio access network of a mobile communication system and selecting a synchronization channel to be used for synchronization from the set of synchronization channels according to a determined criterion. The process also includes configuring one or more transmitters of the radio access network to synchronize transmission to a synchronization signal broadcasted on the selected synchronization channel. At least part of the set of synchronization channels is broadcasted by one or more radio systems other than the mobile communication system, and the radio access network operates on a frequency band shared by a plurality of radio access networks.

Embodiments of the invention are defined in the dependent claims.

### LIST OF DRAWINGS

Embodiments of the present invention are described below, by way of example only, with reference to the accompanying drawings, in which

FIG. 1 illustrates a radio communication environment in which embodiments of the invention may be realized;

FIG. 2 illustrates frequency band allocation in a modern communication system employing shared frequency bands;

FIG. 3 is a signaling diagram illustrating a synchronization procedure according to an embodiment of the invention;

FIG. 4 illustrates a frame structure of a GSM communication system;

FIG. 5 illustrates frame-numbering offset between two radio systems;

FIG. 6 is a block diagram illustrating a network controller according to an embodiment of the invention, base stations of two radio networks, and interconnections between the controller and the base stations;

FIG. 7 is a flow diagram illustrating a general procedure for performing synchronization according to an embodiment of the invention;

FIG. 8 is a flow diagram illustrating a detailed procedure for performing synchronization according to an embodiment of the invention in a base station; and

FIG. 9 is a flow diagram illustrating a detailed procedure for performing synchronization according to an embodiment of the invention in the network controller.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

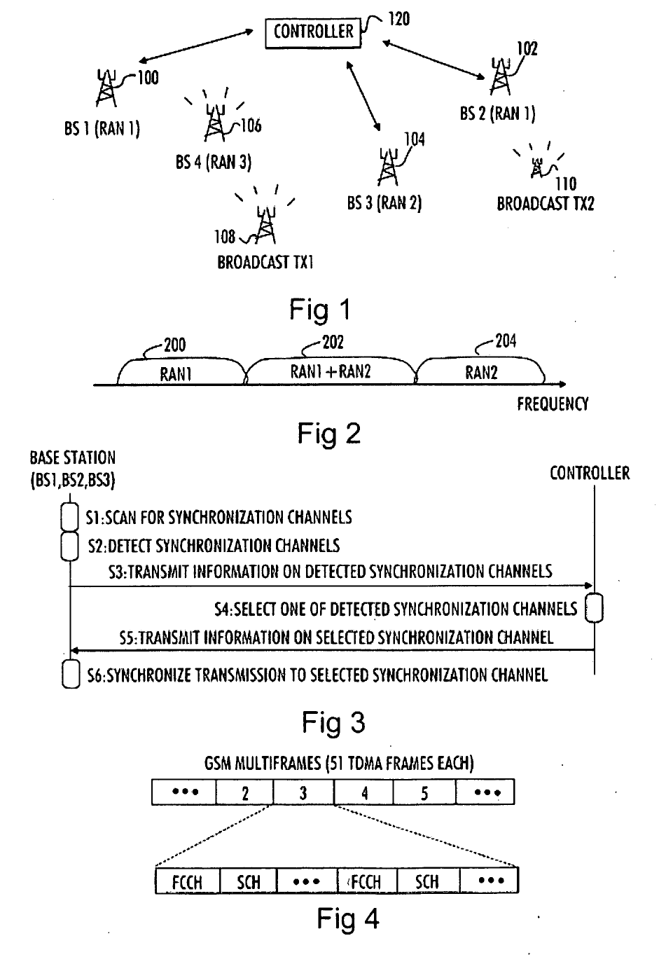

FIG. 1 illustrates an environment in which transmission synchronization according to embodiments of the invention may be carried out. Referring to FIG. 1, multiple radio access networks RAN1, RAN2, RAN3 provide radio coverage in overlapping geographical areas. Let us assume that a first radio access network RAN1 and a second radio access network RAN2 are radio access networks of modem cellular communication systems providing high data rate services and also employing private base stations in their radio access networks. Accordingly, the modem cellular communication systems may both be long-term evolution versions of Universal Mobile Telecommunication System (UMTS), for example. The first and second radio access networks RAN1 and RAN2 may be operated by different network operators. A third radio access network RAN3 is a previous generation cellular telecommunication system, such as Global System for Mobile Communications (GSM). The same geographical area may also be covered by another radio system configured to only broadcast information. An example of such a system is a terrestrial Digital Video Broadcasting system (DVB-T). Base stations 100 and 102 belong to the first radio access network, base station 104 belongs to the second radio access network, base station 106 belongs to the third radio access network, and broadcast stations 108 and 110 belong to the broadcast radio system.

Let us further assume that flexible spectrum use is employed between the first radio access network RAN1 and the second radio access network RAN2. FIG. 2 illustrates spectrum allocation for flexible spectrum use. A frequency band 200 is permanently allocated to the first radio access network RAN1, i.e. frequency band 200 is utilized only by the first radio access network RAN1. Similarly, frequency band 204 is permanently allocated to the second radio access network RAN2, i.e. frequency band 204 is utilized only by the second radio access network RAN2. A shared frequency band 202 is allocated to both first and second radio access network RAN1 and RAN2. In use, the allocated proportions of the shared frequency band may vary according to, for example, capacity requirements of the radio access networks.

According to an embodiment of the invention, base stations 100 to 104 of the first and second radio access networks are configured to detect synchronization signals transmitted by radio systems other than the one they are part of and further configured to acquire synchronization to the detected synchronization signals. The other radio systems whose synchronization signal is to be used for synchronization may include any terrestrial communication system, e.g. a cellular telecommunication system, a broadcast radio system, a radio system dedicated for simply broadcasting a synchronization signal, etc. In order to provide efficient time and frequency synchronization, a synchronization signal to which the synchronization is performed preferably has a frequency equal to or higher than a maximum symbol rate utilized in the radio access networks synchronizing to the synchronization signal. For example, a synchronization signal having a frequency in the order of a few kHz does not provide synchronization accurate enough for a modern communication system utilizing bandwidths in the order of MHz.

The selection of synchronization signals to which the base stations 100 to 104 are to be synchronized may be carried out by a common controller 120 communicating with the base stations 100 to 104. The procedure for synchronizing the radio access networks RAN1 and RAN2 is next described with reference to a signaling diagram of FIG. 3. Referring to FIG. 3, a base station scans for synchronization channels of radio systems other than the one the base station belongs to in S1. The base station may be any one of the base stations 100 to 104 of the first or second radio access network. In our example, the base station is a base station of an enhanced UMTS radio access network (E-UTRAN). The base station is in this example configured to monitor synchronization channels broadcasted by GSM and DVB-T radio systems. Additionally, the base station may be configured to monitor synchronization channels broadcasted by the other E-UTRAN. In practice, the base station may be configured to monitor specific frequency bands in which monitored one or more other radio systems broadcast synchronization channels.

FIG. 4 illustrates a frame structure for (common) control channels of GSM. A GSM common channel multiframe comprises 51 TDMA (time division multiple access) frames, and a synchronization channel (SCH) is transmitted 5 in each common channel multiframe, every tenth TDMA frame (1^{st}, 11^{th}, etc.). A frequency correction channel (FCCH) is transmitted in previous TDMA frames (frame numbers 0, 10, etc.), and the frequency correction channel is used for frequency error correction. The base station may be configured to monitor the SCH and FCCH of the GSM system, but also similar channels of other radio systems that are candidates for the synchronization.

In S2, the base station carries out detection of the scanned synchronization channels. For each monitored synchronization channel, the base station may carry out test acquisition in order to test whether or not the base station is able to acquire synchronization to a synchronization signal on that synchronization channel. Referring to FIG. 1, let us consider that the base station is the first base station 100 of RAN1. The base station 100 receives the synchronization channels broadcasted by RAN2, RAN3 and the broadcast radio system. Accordingly, the base station may perform down-conversion, analog-to-digital conversion, and other processing necessary to convert the signals on the received synchronization channels into digital base band signals. Then, a processing unit of the base station may be configured to execute a synchronization algorithm so as to acquire synchronization to a signal received on a synchronization channel broadcasted by, for example, RAN2. If synchronization to the signal received on a synchronization channel broadcasted by RAN2 is acquired, the processing unit may determine that the synchronization channel of RAN2 has been detected. On the other hand, if synchronization to the signal received on a synchronization channel broadcasted by RAN2 is not acquired, the processing unit may determine that the synchronization channel of RAN2 cannot be detected. Similarly, the processing unit may execute the synchronization algorithm so as to acquire synchronization to signal(s) received on synchronization channel(s) broadcasted by other radio systems, that is RAN3 and the broadcast radio system in this example, and determine whether or not the synchronization channels are detected.

Then, the base station is configured to transmit in S3 to the controller 120 the information on detected synchronization channels (or radio systems) to which the base station is capable of acquiring synchronization. Steps S1, S2, and S3 are carried out in each base station 100 to 104, i.e. each base station 100 to 104 informs the controller 120 about the synchronization channels they have detected. Let us now assume that the first base station 100 is able to detect the synchronization channels broadcasted by RAN3 and the broadcast radio system, the second base station 102 is able to detect the synchronization channels broadcasted by RAN2 and the broadcast radio system, and the third base station 104 is able to detect the synchronization channels broadcasted by RAN1 and the broadcast radio system.

Upon reception of information on the synchronization channels detected by the base stations 100 to 104, the controller 120 selects one of the detected synchronization channels to which the base stations should synchronize their transmission. The selection of the synchronization channel is carried out in S4. The controller 120 may select the synchronization according to a determined criterion. One example of the criterion is the availability of the synchronization channels to the base stations, i.e. detectability of the synchronization channels. Another example of the criterion is that the controller 120 selects a synchronization channel to which the highest number of base stations is able to acquire synchronization. Yet another example of the criterion is that the controller 120 selects a synchronization channel to which the highest number of private base stations is able to acquire synchronization. In our example, all base stations 100 to 104 of RAN1 and RAN2 are able to synchronize to the broadcast radio system and, therefore, the controller 120 may select the synchronization channel of the broadcast radio system.

In S5, the controller 120 transmits information on the selected synchronization channel to the base stations 100 to 104, and the base stations 100 to 104 synchronize their transmission to the signal broadcasted by the broadcast radio system on the selected synchronization channel in S6. In more detail, the base stations 100 to 104 may acquire time and frequency synchronization to the signal on the selected synchronization channel.

Accordingly, the controller 120 is configured to synchronize transmission of two (or more) radio access networks to the selected synchronization channel, i.e. to the transmission of a selected radio system. In particular, the controller 120 may be configured to synchronize the transmission of radio access networks sharing the same frequency band in a time-division manner to a common synchronization source or a reference signal. Since the radio access networks, which may alternately occupy the same frequency band, are synchronized to the common reference signal, the frequency band may be allocated effectively such that interference between the radio access networks is minimized. In particular, simultaneous occupation of the same frequency due to lack of time synchronization and/or frequency drift caused by lack of frequency synchronization is prevented when using a common reference signal. The controller may be configured to select the same synchronization channel for base stations in a determined geographically limited area where the radio access networks share the same frequency band.

The controller 120 may be configured to also perform the frequency band allocation to the radio access networks, or the frequency band allocation may be carried out by another controller. In an embodiment, the controller performing the frequency band allocation is configured to acquire information on operational frequency bands currently occupied by the one or more radio systems other than those controlled by the controller. The information on the operational frequency bands may be obtained from broadcast information broadcasted by the one or more other radio systems. The base stations controlled by the controller may acquire such information in S2 and transmit the information to the controller in S3 (FIG. 3). Then, the controller may utilize the acquired information on the operational frequency bands currently occupied by the one or more other radio systems when allocating a frequency band to the one or more transmitters. In more detail, the controller 120 may allocate frequency bands not currently occupied by the other radio systems to the base station under the control of the controller 120. This embodiment is advantageous, for example, in such a case where there are other radio systems allocated to the shared frequency band, and these other radio systems are not controlled by the controller. The controller may acquire the information on the operational frequency bands currently occupied by the one or more other radio systems also directly from the other radio systems through network signaling and, thus, there is no need to use the base stations in the acquisition of the information.

The example above presented a desired scenario where all the base stations 100 to 104 were able to detect the same synchronization channel and, thus, the selection of the synchronization channel was simple. Let us next consider a case where the first base station 100 is not able to detect the synchronization channel of the broadcast radio system. Accordingly, the first base station 100 transmits in S3 information indicating the incapability to detect the synchronization channel of the broadcast radio system. Then, the controller 120 considers the fact in the selection of the synchronization channel in S4.

In case the first base station 100 is a public base station of the first radio access network and the first radio access network utilizes synchronous transmission among at least neighboring base stations, the synchronization between the base stations of the same radio access network is acquired by other means, e.g. through the utilization of an internal reference clock signal in the first radio access network. Accordingly, synchronization of the first base station 100 to a reference signal not detected by the first base station 100 may be achieved as long as at least one element of the radio access network is able to detect the synchronization channel selected by the controller 120. This may be carried out by utilizing the internal reference signal of the first radio access network RAN1 and the synchronization signal on the selected synchronization channel.

As a consequence, the controller may select in S4 a synchronization channel which is detected by all radio access networks to be configured to synchronize their transmission to the same synchronization channel. This may be a condition after it has been determined that not all the base stations controlled by the controller 120 are able to detect the same synchronization channel. Let us consider this new example, where the first base station 100 is able to detect only the synchronization channel broadcasted by RAN3, the second base station 102 is able to detect the synchronization channels broadcasted by RAN2 and the broadcast radio system, and the third base station 104 is able to detect the synchronization channels broadcasted by RAN1 and the broadcast radio system. Now, the controller may select in S4 the synchronization channel broadcasted by RAN1, because the third base station is able to detect that and the synchronization channel is bound to the internal clock of RAN1 known to both first and second base station 100,102. Synchronization to the synchronization channel of one of the radio access networks controlled by the controller 120 may even be preferred over synchronization to a synchronization channel of a third party not controlled by the controller 120.

Let us take the example one step further and assume a case where the second base station is not able to detect the synchronization channel broadcasted by RAN2, and the third base station 104 is not able to detect the synchronization channel broadcasted by RAN1. Accordingly, the first base station 100 is now able to detect only the synchronization channel broadcasted by RAN3, the second base station 102 is able to detect only the synchronization channel broadcasted by the broadcast radio system, and the third base station 104 is able to detect only the synchronization channel broadcasted by the broadcast radio system. Now, the only synchronization channel both radio access networks RAN1 and RAN2 are able to detect is the synchronization channel broadcasted by the broadcast radio system. Therefore, the controller 120 selects the synchronization channel broadcasted by the broadcast radio system in S4. Since the first base station 100 is, however, not able to detect the selected synchronization channel, the controller 120 may provide the first base station 100 with additional synchronization information that facilitates the synchronization of the first base station 100 to the selected synchronization channel. Such additional information may comprise timing difference between the reference system and the internal clock of the radio access network the first base station 100 belongs to (RAN1). Accordingly, the controller 120 may in S5 provide the first base station 100 with timing difference information indicating the timing difference between the broadcast radio system selected in S4 and the internal clock of RAN1. Furthermore in S5, the controller 120 provides the second and third base station 102, 104 with information indicating that the synchronization channel of the radio broadcast system is selected as the system to which synchronization is to be carried out. The second and third base station 102, 104 carry out step S6 as described above. The first base station carries out step S6 by applying the timing difference information to the internal clock of RAN1 in order to offset timing of the internal clock with the timing difference information in order to synchronize transmission to the broadcast radio system.

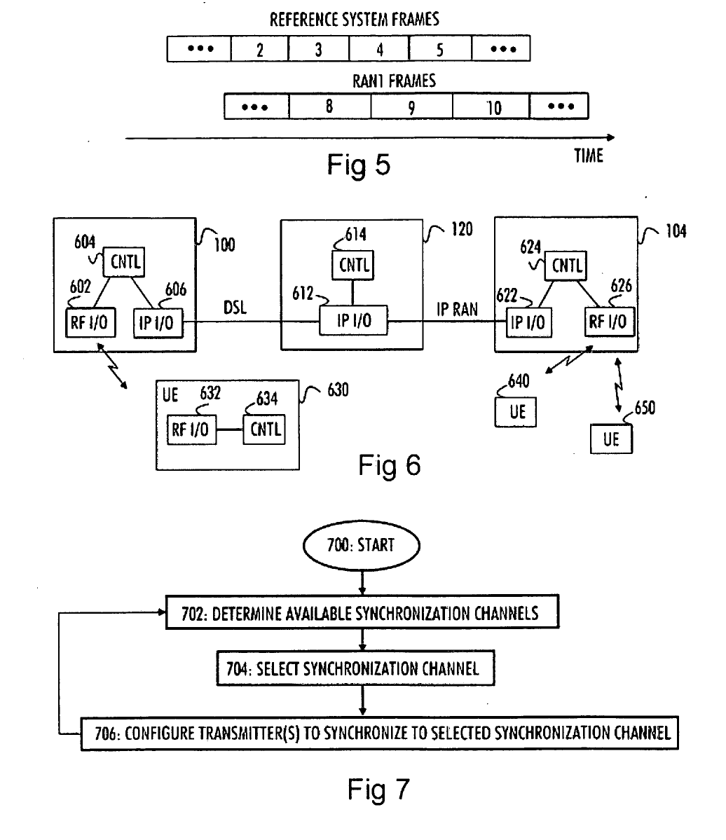

The timing difference may include information on an offset between the frame numbering between the radio system selected in S4 and RAN1. FIG. 5 illustrates an example of a difference in frame numbering of the two systems. As can be seen, there is a time offset between the frame numbering of the reference system, i.e. the system selected in S4, and RAN1. As illustrated in FIG. 5, there is also a difference between the frame lengths of the two systems. Accordingly, the controller 120 may inform the first base station 100 of the timing difference, e.g. the frame number offset, between the frame numbering of the two systems at a given time point, and the first base station 100 may then determine how the timing difference evolves in time. In fact, the frame numbering offset evolves as a linear function due to the fixed ratio between the frame lengths of the two systems and, as a consequence, the change in the frame numbering at a desired time point may be easily calculated. Accordingly, the first base station may acquire synchronization to the broadcast radio system, whose synchronization channel it cannot detect, by applying the offset given by the controller to its internal reference clock.

Let us still consider another scenario, where the first base station 100 is a private base station not able to acquire synchronization to the internal clock of RAN1. As mentioned in the background section, the private base stations are connected to an operator network (and to the controller 120) through xDSL (Digital Subscriber line) connections. Information exchange between a private base station and neighboring base stations is very limited and slow and, thus, synchronization between a private base station and the public radio access network it relates to (the radio access network of the same operator) may not be possible. The second and third base stations 102, 104 may be public or private base stations.

As in the previous example, the first base station 100 (the private base station) is now able to detect only the synchronization channel broadcasted by RAN3, the second base station 102 is able to detect only the synchronization channel broadcasted by the broadcast radio system, and the third base station 104 is able to detect only the synchronization channel broadcasted by the broadcast radio system.

As in the previous example, the controller 120 may select the synchronization channel broadcasted by the broadcast radio system in S4 also in this example, because most base stations are able to detect that synchronization channel. Since the first base station 100 is, however, not able to detect the selected synchronization channel, the controller 120 may provide the first base station 100 with additional synchronization information that facilitates the synchronization of the first base station 100 to the selected synchronization channel. Such additional information may in this case comprise a timing difference between the reference system and the synchronization signal of a synchronization channel the first base station 100 is able to detect. Accordingly, the controller 120 may in S5 provide the first base station 100 with timing difference information indicating the timing difference between the broadcast radio system selected in S4 and the system having the synchronization channel the first base station 100 is able to detect (RAN3 in this case). The timing difference may comprise information on the frame-numbering offset between the two systems at a given time instant. Then, the first base station may in S6 synchronize to the synchronization channel of RAN3, read the current frame number from the information broadcasted by RAN3 on the synchronization channel and calculate and keep track of the evolving timing offset between the broadcast radio system and RAN3. Information on the frame lengths of both systems may be stored in the first base station 100 beforehand, or the controller 120 may inform it. Accordingly, the first base station 100 is capable of synchronizing its transmission to the selected synchronization channel even though it is not able to detect neither the selected synchronization channel nor the internal reference clock of its own radio access network.

Allocation of the frequency band shared by the plurality of radio access networks may now be carried out by providing a reference to the common reference signal, to which the plurality of radio access networks are synchronized. For example, a given transmitter of the first radio access network may be configured to release a given frequency band from a certain instant of the common reference signal onwards, while another transmitter of the second radio access network may be configured to occupy the same frequency band from the same instant of the common reference signal onwards. Since the two radio access networks are synchronized to the same common reference signal, the reallocation of the frequency band is carried out without interference between the two transmitters. Naturally, a guard time interval may be provided between the release and occupation of the frequency band.

FIG. 6 illustrates exemplary structures of the base stations 100, 104 and the common controller 120 and their interconnections. Let us consider the scenario where the first base station 100 is the private base station. The common controller 120 carrying out the selection of the synchronization channel for the base stations 100, 102, 104 on the shared frequency band comprises an interface 612 to provide the controller 120 with communication capabilities with the base stations and other elements of the communication systems with which the controller operates. If the controller 120 and the base stations 100, 104 are implemented in separate locations distant from each other, the connections between the controller 120 and the base stations 100, 104 may be implemented as Internet protocol (IP) connections. Accordingly, in such an embodiment, the interface 612 may be realized by a communication unit capable of transferring IP data packets. The IP connection with the private base station 100 is routed through the DSL network through appropriate DSL network entities, and the IP connection with the public base station may be routed through the IP radio access network of a corresponding operator and possibly through other IP networks depending on the location of the controller 120. On the other hand, if the controller is realized in one of the base stations the controller 120 controls, the interface 612 may also be seen as a baseband communication interface or even as an interface between two computer programs executed in the same processor or a group of processors.

The controller 120 further comprises a processor 614 configured to control operations of the controller 120, to carry out the selection of the synchronization channel for base stations allocated to a shared frequency band on the basis of synchronization channels detected by the base stations, and to configure the base stations to synchronize their data transmission to a synchronization signal on the selected synchronization channel. The processor 614 may be implemented by a digital signal processor configured by one or more computer programs executed by the processor 614. Alternatively, the processor 614 may be implemented by an application-specific integrated circuit, a micro-controller, or any other type of processor.

The base stations 100, 104 each comprise an interface 606, 622, configured to establish a communication connection with the controller 120. The interface 606, 622 may be configured to carry out the communication with the corresponding interface 612 of the controller 120. In the example of FIG. 6, the interfaces 606, 622 establish the IP connection. The first base station 100 being the private base station establishes the connection through the DSL network, i.e. the interface 606 of the private base station is configured to establish the communication connection with the controller through a local DSL network. The interface 622 of the third base station (public base station) is configured to establish the IP communication connection with the controller 120 through a local IP radio access network and possibly through other IP communication networks.

Each base station 100, 104 additionally comprises a processor 604, 624 configured to control operations of the base station 100, 104, to monitor determined synchronization channel so as to determine which one or more synchronization channels the base station 100, 104 is able to detect, to transmit information on the detected synchronization channels to the controller 120 through the interface 606, 622, and to synchronize its data transmission to the synchronization channel selected by the controller 120 under the control of instructions received from the controller 120 through the interface 606, 622. The processor 604, 624 may be implemented by a digital signal processor configured by one or more computer programs executed by the processor 604, 624. Alternatively, the processor 604, 624 may be implemented by an application-specific integrated circuit, a micro-controller, or any other type of processor.

Each base station 100, 104 further comprises a radio communication unit 602, 626 configured to establish a radio interface connection with one or more user terminals 630, 640, 650 the base station 100, 104 is configured to serve. The processor 604, 624 of the base station 100, 104 may be configured to synchronize the transmission of the user terminals 630, 640, 650 to the same synchronization source to which the base station 100, 104 itself is synchronized so as to ensure that also uplink communication directions of the radio access networks on the shared frequency band are synchronized with respect to each other. The configuration of the user terminals 630, 640, 650 is carried out through the radio communication unit 602, 626 of the base station and corresponding radio communication units 632 of the user terminals 630, 640, 650. Each user terminal 630, 640, 650 further comprises a processing unit 634 configured to control the operations of the user terminal. In particular, the processing unit 634 is configured to synchronize the transmission of the user terminal to a synchronization source under the control of the base station. The base station may configure the user terminal to synchronize its transmission to a synchronization signal broadcasted by the base station. Alternatively, the base station may configure the user terminal to acquire the synchronization from the selected synchronization channel directly, i.e. to synchronize its transmission to a synchronization signal broadcasted by another radio system. In such a case, the transmission of both the base station and the user terminal is synchronized to the same synchronization signal broadcasted by the other radio system.

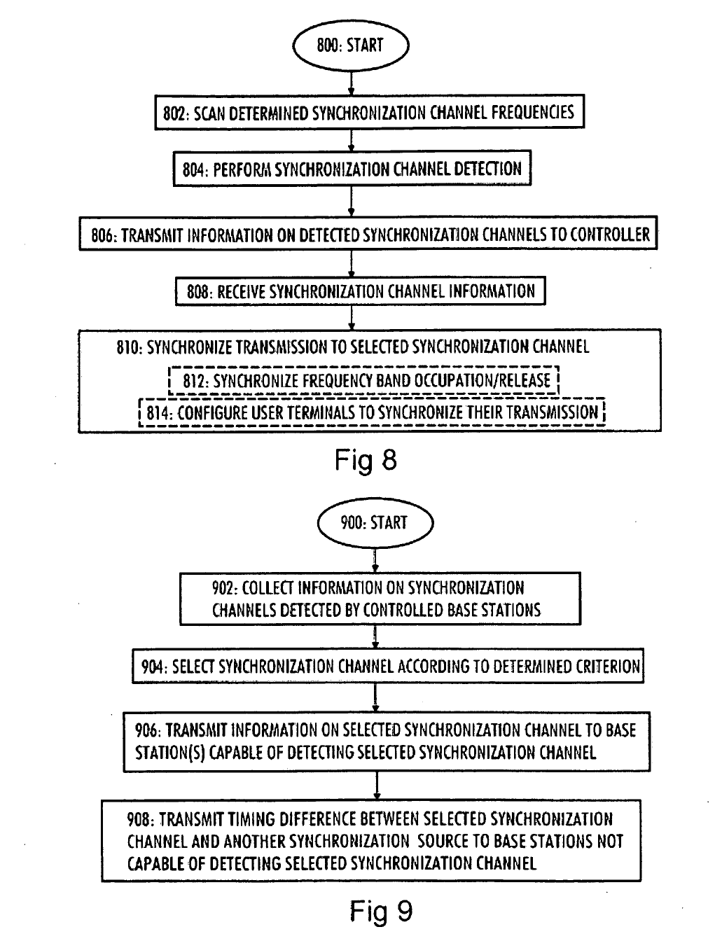

Next, let us describe a general procedure of a process for synchronizing transmission of one or more radio access networks allocated to a shared frequency band with reference to FIG. 7. A more detailed description of the process is described below with reference to FIGS. 8 and 9 illustrating the general procedure of FIG. 7 for the base station (FIG. 8) and for the controller (FIG. 9). The processes described below may be realized as computer processes executed in a processor.

With reference to FIG. 7, the process starts in block 700. In block 702, the availability of a set of synchronization channels for use in a radio access network a mobile communication system is determined. At least part of the set of synchronization channels is broadcasted by one or more radio systems other than said mobile communication system. In block 704, a synchronization channel to be used for synchronization purposes is selected from the set of synchronization channels according to a determined criterion. In block 706, one or more transmitters of the radio access network are configured to synchronize transmission to a synchronization signal broadcasted on the selected synchronization channel.

As mentioned above, FIG. 7 describes the synchronization process on a general level. FIG. 8 provides a more detailed description of an embodiment in which the process of FIG. 7 is carried out in a base station allocated to the shared frequency band. The process of FIG. 8 may be carried out by the processor of the base station. The process starts in block 800. In block 802, the base station scans determined synchronization channel frequencies in order to receive radio signals on the frequencies for determination of the availability of the synchronization channels. The synchronization channels to be scanned may be determined according to the capabilities of the base station and/or the set of synchronization channels that can in general be used for common synchronization. Each radio system may broadcast the synchronization channel in different waveforms, and the base station should be configured to detect these waveforms in order to detect the synchronization channel. In block 804, the base station performs a detection procedure for the signals received on the scanned synchronization channel frequencies. The detection is made for each synchronization channel separately in order to determine whether or not the base station is able to detect a signal on a given synchronization channel. Accordingly, the base station determines the availability of the set of synchronization channels for use by determining the synchronization channel(s) the base station is capable of detecting.

In block 806, the base station transmits information on the detected synchronization channel(s) to the controller determining which synchronization channel should be used as a common synchronization source for the transmitters sharing the same frequency band. In block 808, the base station receives information concerning the synchronization of the base station. If the common synchronization source is a synchronization channel the base station is able to detect, the received information may comprise an identifier of the synchronization channel. If the common synchronization source is a synchronization channel the base station is not able to detect, the received information may comprise a timing offset indicator indicating a timing difference between the common synchronization source and a reference signal to which the base station is able to synchronize its transmission.

In block 810, the base station synchronizes transmission in a control area of the base station to the selected synchronization channel. If the common synchronization source is the synchronization channel the base station is able to detect, the base station synchronizes its transmission directly to the synchronization signal in the selected synchronization channel. If the common synchronization source is the synchronization channel the base station is not able to detect, the base station utilizes the timing difference defined by the received timing offset indicator by adding the timing difference to the reference signal to which the base station is able to synchronize its transmission.

In particular, the base station synchronizes its own transmission and the transmission of user terminals communicating with the base station to the selected synchronization channel (block 814). In particular, the base station synchronizes the utilization of the shared frequency band to the selected synchronization channel (block 812). In more detail, the base station may receive frequency band allocation information from a radio resource controller of a radio access network of the base station. The frequency band allocation information may indicate, for example, a frequency resource allocated to the base station and a frame number (or another time indicator) from which onwards the frequency resource is available to the base station, wherein the frame number is the frame number indicated on the selected synchronization channel, i.e. the synchronization channel indicates a current frame number continuously.

Then, the base station may continue the process by returning to block 802. The base station may be configured to periodically scan for the determined synchronization channels so as to enable dynamic reallocation of the common synchronization source.

FIG. 9 provides a more detailed description of an embodiment in which the process of FIG. 7 is carried out in controller 120 configured to control base stations of difference radio access networks allocated to the shared frequency band. The process of FIG. 9 may be carried out by the processor of the controller 120. The process starts in block 900. In block 902, the controller collects information on synchronization channels detected by base stations the controller is configured to control. In block 904, the controller selects the synchronization channel to be used as a common synchronization source for the base stations. The selection is carried out according to a determined criterion. A primary criterion may be to select a synchronization channel all the base stations are able to detect. If this is not the case, the controller may select a synchronization channel which is detected by at least one base station of each radio access network. Alternatively, the controller may select a synchronization channel which is detected by the highest number of base stations. In a further alternative embodiment, the controller may select a synchronization channel such that it is possible for each base station to acquire synchronization to that synchronization channel by utilizing another reference clock and a timing offset between the synchronization channel and the other reference clock.

Then, the controller transmits in block 906 information indicating the selected synchronization channel to base station(s) capable of detecting the synchronization channel. This information may also be transmitted to base station(s) not capable of detecting the synchronization channel in order to indicate the selection of the synchronization channel. Additionally, the controller may transmit in block 908 information on a timing difference between the selected synchronization channel and another reference clock or a synchronization source to the base station(s) not capable of detecting the selected synchronization channel. If all the base stations are capable of detecting the selected synchronization channel, block 908 may be omitted.

Then, the controller may continue the process by returning to block 902. The controller may be configured to select the synchronization channel periodically so as to enable dynamic reallocation of the common synchronization source.

The processes or methods described in FIGS. 7 to 9 may also be carried out in the form of a computer process defined by a computer program. The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to cellular or mobile telecommunication systems defined above but also to other suitable telecommunication systems. An example of such other telecommunication system is an ad hoc network comprising two radio communication devices configured to establish a radio connection with each other directly through a radio interface. In such an embodiment, the radio transmitters may negotiate a common synchronization source to which the transmission should be synchronized. The synchronization source may a signal broadcasted by another radio transmitter or system.

The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method, comprising:
determining the availability of a set of synchronization channels for use in a radio access network of a mobile communication system, wherein at least part of the set of synchronization channels is broadcasted by one or more radio systems other than said mobile communication system and wherein the radio access network operates on a frequency band shared by a plurality of radio access networks;
selecting a synchronization channel to be used for synchronization from the set of synchronization channels according to a determined criterion; and
configuring one or more transmitters of the radio access network to synchronize transmission to a synchronization signal broadcasted on the selected synchronization channel.

2. The method of claim 1, the configuration of the one or more transmitters further comprising configuring the one or more transmitters to acquire at least one of time synchronization and frequency synchronization to the synchronization signal broadcasted on the selected synchronization channel.

3. The method of claim 1, further comprising configuring the one or more transmitters to utilize the shared frequency band in synchronization to the synchronization signal broadcasted on the selected synchronization channel.

4. The method of claim 1, wherein the shared frequency band is dynamically allocated to the radio access networks of the multiple mobile communication systems synchronized to the synchronization signal broadcasted on the selected synchronization channel.

5. The method of claim 1, further comprising:
acquiring information on operational frequency bands currently occupied by the one or more radio systems other than said mobile communication system from broadcast information broadcasted by the one or more radio systems; and
allocating frequency resources to the one or more transmitters on the basis of the acquired information on the operational frequency bands currently occupied by the one or more radio systems.

6. The method of claim 1, further comprising:
receiving, in a network controller configured to control synchronization of the plurality of radio access networks sharing the frequency band, information on synchronization channels detected by each of a plurality of transmitters of the plurality of radio access networks; and
selecting a synchronization channel which has been detected by the highest number of transmitters as the synchronization channel to be used for synchronization.

7. The method of claim 1, further comprising:
receiving, in a network controller configured to control synchronization of the plurality of radio access networks sharing the frequency band, information on synchronization channels detected by each of a plurality of transmitters of the plurality of radio access networks; and
selecting a synchronization channel which has been detected by at least one transmitter of each radio access network sharing the frequency band as the synchronization channel to be used for synchronization.

8. The method of claim 1, further comprising:
determining an offset between the synchronization signal broadcasted on the selected synchronization channel and another synchronization source of a transmitter determined not to be able to detect the selected synchronization channel; and
configuring the transmitter determined not to be able to detect the selected synchronization channel to synchronize to the synchronization signal broadcasted on the selected synchronization channel by utilizing the other synchronization source of the transmitter and the determined offset between the synchronization signal broadcasted on the selected synchronization channel and the other synchronization source of the transmitter.

9. The method of claim 1, wherein the synchronization signal on the selected synchronization channel has a frequency equal to or higher than a maximum symbol rate utilized in the plurality of radio access networks.

10. The method of claim 1, further comprising:
monitoring, in a transmitter of the radio access network of the mobile communication system, one or more synchronization channels of the one or more radio systems other than the mobile communication system;
performing, in the transmitter of the radio access network, a detection procedure in order to determine whether or not one or more synchronization signals on the monitored one or more synchronization channels are detected; and
transmitting information on the one or more detected synchronization channels from the transmitter to a network controller for selection of the synchronization channel.

11. The method of claim 1, further comprising: synchronizing, in the transmitter of the radio access network of the mobile communication system, the utilization of a frequency band to the synchronization signal on the selected synchronization channel.

12. The method of claim 1, wherein the set of synchronization channels is broadcasted by one or more terrestrial radio systems.

13. The method of claim 1, wherein the plurality of radio access networks sharing the frequency band are operated by different operators.

14. The method of claim 1, wherein the plurality of radio access networks sharing the frequency band communicate according to different radio communication protocols.

15. An apparatus comprising a processor configured to determine the availability of a set of synchronization channels for use in a radio access network of a mobile communication system, wherein at least part of the set of synchronization channels is broadcasted by one or more radio systems other than said mobile communication system and wherein the radio access network operates on a frequency band shared by a plurality of radio access networks, to select a synchronization channel to be used for synchronization from the set of synchronization channels according to a determined criterion, and to configure one or more transmitters of the radio access network to synchronize transmission to a synchronization signal broadcasted on the selected synchronization channel.

16. The apparatus of claim 15, wherein the processor is further configured to configure the one or more transmitters to acquire at least one of time synchronization and frequency synchronization to the synchronization signal broadcasted on the selected synchronization channel.

17. The apparatus of claim 15, wherein the processor is further configured to configure the one or more transmitters to utilize the shared frequency band in synchronization to the synchronization signal broadcasted on the selected synchronization channel.

18. The apparatus of claim 15, further configured to operate the one or more radio transmitters utilizing the shared frequency band which is dynamically allocated to the radio access networks of the multiple mobile communication systems synchronized to the synchronization signal broadcasted on the selected synchronization channel.

19. The apparatus of claim 15, configured to operate in a network controller controlling one or more radio access network, wherein the processor is further configured to acquire information on operational frequency bands currently occupied by the one or more radio systems other than said mobile communication system from broadcast information broadcasted by the one or more radio systems and to allocate frequency resources to the one or more transmitters on the basis of the acquired information on the operational frequency bands currently occupied by the one or more radio systems.

20. The apparatus of claim 15, configured to operate in a network controller configured to control synchronization of the plurality of radio access networks sharing the frequency band, wherein the processor is further configured to receive information on synchronization channels detected by each of a plurality of transmitters of the plurality of radio access networks and to select a synchronization channel which has been detected by the highest number of transmitters as the synchronization channel to be used for synchronization.

21. The apparatus of claim 15, configured to operate in a network controller configured to control synchronization of the plurality of radio access networks sharing the frequency band, wherein the processor is further configured to receive information on synchronization channels detected by each of a plurality of transmitters of the plurality of radio access networks and to select a synchronization channel which has been detected by at least one transmitter of each radio access network sharing the frequency band as the synchronization channel to be used for synchronization.

22. The apparatus of claim 15, wherein the processor is further configured to determine an offset between the synchronization signal broadcasted on the selected synchronization channel and another synchronization source of a transmitter determined not to be able to detect the selected synchronization channel and to configure the transmitter determined not to be able to detect the selected synchronization channel to synchronize to the synchronization signal broadcasted on the selected synchronization channel by utilizing the other synchronization source of the transmitter and the determined offset between the synchronization signal broadcasted on the selected synchronization channel and the other synchronization source of the transmitter.

23. The apparatus of claim 15, wherein the synchronization signal on the selected synchronization channel has a frequency equal to or higher than a maximum symbol rate utilized in the plurality of radio access networks.

24. The apparatus of claim 15, configured to operate in a transmitter of the radio access network of the mobile communication system, further comprising:
a first interface configured to receive broadcast radio signals broadcasted on one or more broadcast channels of the one or more radio systems other than the mobile communication system;
a second interface configured to enable a communication connection with a network controller controlling the synchronization of the transmitter,
wherein the processor is further configured to monitor the one or more synchronization channels, to perform a detection procedure in order to determine whether or not one or more synchronization signals on the monitored one or more synchronization channels are detected, and to transmit information on the one or more detected synchronization channels through the second interface to the network controller for selection of the synchronization signal.

25. The apparatus of claim 15, configured to operate in a transmitter of the radio access network of the mobile communication system, wherein the processor is further configured to synchronize the utilization of a frequency band to the synchronization signal on the selected synchronization channel.

26. The apparatus of claim 15, wherein the set of synchronization channels is broadcasted by one or more terrestrial radio systems.

27. The apparatus of claim 15, wherein the plurality of radio access networks sharing the frequency band are operated by different operators.

28. The apparatus of claim 15, wherein the plurality of radio access networks sharing the frequency band communicate according to different radio communication protocols.

29. An apparatus, comprising:
means for determining the availability of a set of synchronization channels for use in a radio access network of a mobile communication system, wherein at least part of the set of synchronization channels is broadcasted by one or more radio systems other than said mobile communication system and wherein the radio access network operates on a frequency band shared by a plurality of radio access networks;
means for selecting a synchronization channel to be used for synchronization from the set of synchronization channels according to a determined criterion; and
means for configuring one or more transmitters of the radio access network to synchronize transmission to a synchronization signal broadcasted on the selected synchronization channel.

30. A computer program product embodied on a distribution medium readable by a computer and comprising program instructions which, when loaded into an apparatus, execute a computer process comprising:
determining the availability of a set of synchronization channels for use in a radio access network of a mobile communication system, wherein at least part of the set of synchronization channels is broadcasted by one or more radio systems other than said mobile communication system and wherein the radio access network operates on a frequency band shared by a plurality of radio access networks;
selecting a synchronization channel to be used for synchronization from the set of synchronization channels according to a determined criterion; and
configuring one or more transmitters of the radio access network to synchronize transmission to a synchronization signal broadcasted on the selected synchronization channel.
